(19) United States
(12) Patent Application Publication
(10) Pub. No.: US 2024/0426649 A1
(43) Pub. Date: Dec. 26, 2024

(54) INFORMATION PROCESSING DEVICE, INFORMATION PROCESSING METHOD, AND STORAGE MEDIUM

(71) Applicant: NEC Corporation, Tokyo (JP)

(72) Inventors: Noriyuki TONAMI, Tokyo (JP); Wataru KOHNO, Tokyo (JP); Sakiko MISHIMA, Tokyo (JP); Takashi MATSUSHITA, Tokyo (JP); Tomoyuki HINO, Tokyo (JP)

(73) Assignee: NEC Corporation, Tokyo (JP)

(21) Appl. No.: 18/741,955

(22) Filed: Jun. 13, 2024

(30) Foreign Application Priority Data
Jun. 22, 2023 (JP) 2023-102155

(51) Int. Cl. G01H 9/00; G01D 5/353

(52) U.S. Cl. CPC G01H 9/004; G01D 5/35358

(57) ABSTRACT

An information processing device includes an acquisition unit that acquires measurement signals measured at a plurality of measurement points on a laid optical fiber cable, a prediction unit that predicts a predictive environment representing the environment of each of the measurement points from each of the measurement signals by using a prediction model set in advance, and a correction unit that corrects the predictive environment on the basis of a comparison between the predictive environment of each of the measurement points and the measurement signal measured at each of the measurement points.

### INCORPORATION BY REFERENCE

The present invention is based upon and claims the benefit of priority from Japanese patent application No. 2023-102155, filed on Jun. 22, 2023, the disclosure of which is incorporated herein in its entirety by reference.

### TECHNICAL FIELD

The present disclosure relates to an information processing device, an information processing method, and a storage medium.

### BACKGROUND ART

With a technology called optical fiber sensing, it is possible to analyze surrounding environments of a plurality of points along an optical fiber from vibration and sounds applied to the optical fiber. Patent Literature 1 discloses art of specifying the position of a utility pole by sensing vibration and sounds at a plurality of points along an optical fiber by using optical fiber sensing. Specifically, in Patent Literature 1, vibration data for each distance is measured from an optical fiber cable, and the position where the vibration data has a unique pattern is identified as the position of a utility pole.
Patent Literature 1: WO 2020/044648 A

### SUMMARY

However, the art described in Patent Literature 1 merely detects whether or not vibration data has a unique pattern and specifies only the position of a utility pole. Therefore, in the case where vibration data has an unknown pattern, it is impossible to identify the position of a utility pole, and also impossible to specify the position of any object. Moreover, this art causes a problem that it is impossible to accurately recognize the surrounding environment at a given position, without being limited to recognizing existence of an object such as a utility pole at a position around the laid optical fiber cable.

Therefore, an example object of the present invention is to solve the problem described above, that is, a problem that it is impossible to accurately recognize the surrounding environment of a laid optical fiber cable.

An information processing device, according to one aspect of the present disclosure, is configured to include
an acquisition unit that acquires measurement signals measured at a plurality of measurement points on a laid optical fiber cable;
a prediction unit that predicts a predictive environment representing the environment of each of the measurement points from each of the measurement signals by using a prediction model set in advance; and
a correction unit that corrects the predictive environment on the basis of a comparison between the predictive environment of each of the measurement points and the measurement signal measured at each of the measurement points.

Further, an information processing method, according to one aspect of the present disclosure, is configured to include
acquiring measurement signals measured at a plurality of measurement points on a laid optical fiber cable;
predicting a predictive environment representing the environment of each of the measurement points from each of the measurement signals by using a prediction model set in advance; and
correcting the predictive environment on the basis of a comparison between the predictive environment of each of the measurement points and the measurement signal measured at each of the measurement points.

Further, a program, according to one aspect of the present disclosure, is configured to cause a computer to execute processing to
acquire measurement signals measured at a plurality of measurement points on a laid optical fiber cable;
predict a predictive environment representing the environment of each of the measurement points from each of the measurement signals by using a prediction model set in advance; and
correct the predictive environment on the basis of a comparison between the predictive environment of each of the measurement points and the measurement signal measured at each of the measurement points.

With the configurations described above, the present disclosure is capable of accurately recognizing the surrounding environment of a laid optical fiber cable.

### BRIEF DESCRIPTION OF DRAWINGS

FIG. 1 is a block diagram illustrating the overall configuration of an information processing system according to the present disclosure;

FIG. 2 illustrates a state of processing by the information processing system according to the present disclosure;

FIG. 3 is a block diagram illustrating a configuration of a first information processing device according to the present disclosure;

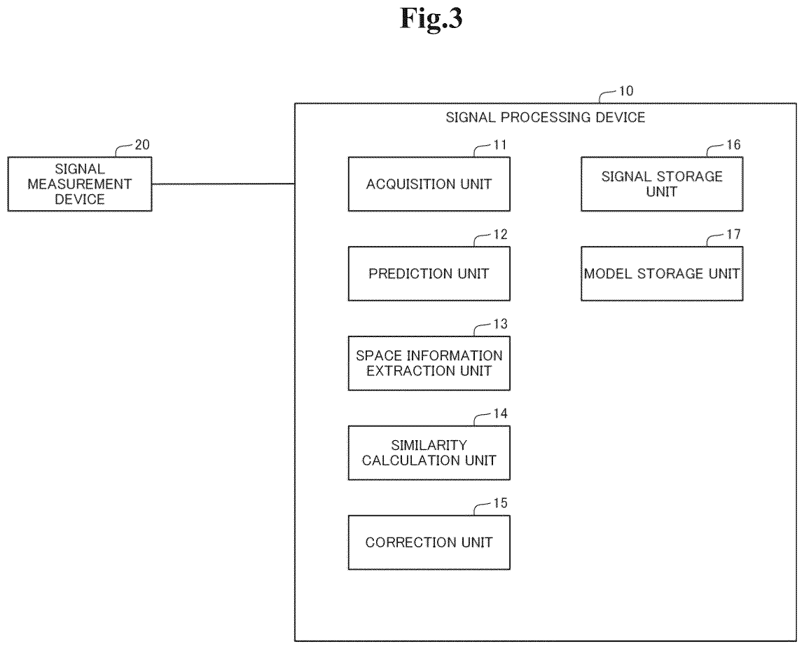

FIG. 4 illustrates a state of processing by the first information processing device according to the present disclosure;

FIG. 5 is a flowchart illustrating a processing operation of the first information processing device according to the present disclosure;

FIG. 6 is a block diagram illustrating a hardware configuration of a second information processing device according to the present disclosure; and

FIG. 7 is a block diagram illustrating a configuration of the second information processing device according to the present disclosure.

### EXAMPLE EMBODIMENTS

### First Example Embodiment

The present disclosure will be described with reference to the drawings. Note that the drawings may relate to any embodiments.

An information processing system according to the present embodiment is used to recognize the surrounding environment of each of a plurality of points along a laid optical fiber cable from measurement signals measured from the optical fiber cable, by using a technology called optical fiber sensing. For example, the information processing system first acquires information such as acoustic and vibration in a time-series manner, by using back-scattered light with respect to incident light as measurement signals, at measurement points along an optical fiber cable. Hereinafter, the measurement signals will be described as time-series signals of acoustic signals or vibration signals. Then, from the acquired time-series signals, the information processing system recognizes an event occurring at a measurement point as the environment of the measurement point. For example, examples of recognizing an event occurring at a measurement point include specifying a signal source such as dog's bark or human footfalls and specifying a place such as a city area, a forest, or a park. Hereinafter, a configuration for realizing such a configuration will be described.

### [Configuration]

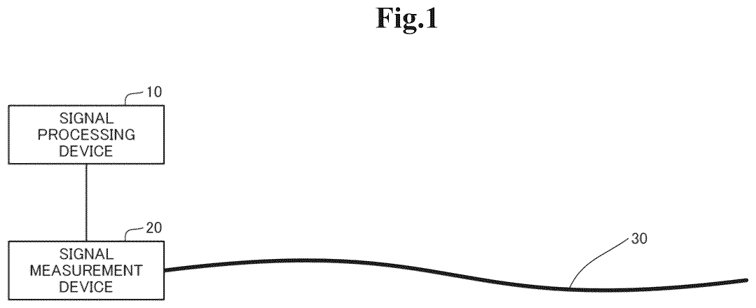

As illustrated in FIG. 1, an information processing system includes a signal processing device 10 and a signal measurement device 20. The signal measurement device 20 is connected to an optical fiber cable 30 laid at a predetermined place and having a predetermined length.

The signal measurement device 20 measures measurement signals at a plurality of points (measurement points, hereinafter referred to as “channels”) along the optical fiber cable 30. The signal measurement device 20 is, for example, a distributed acoustic sensor (DAS), and measures acoustic signals and vibration signals transmitted to the optical fiber cable 30 as measurement signals.

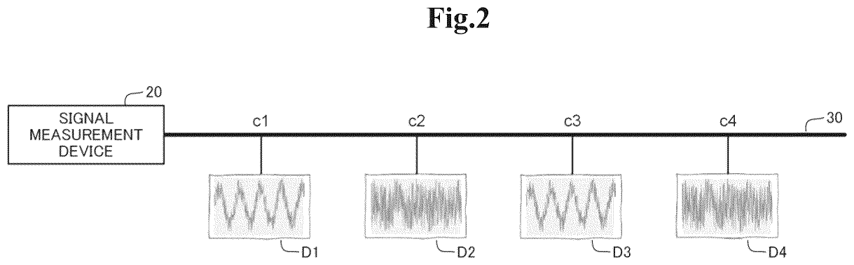

FIG. 2 illustrates a state of measuring measurement signals by the signal measurement device 20. In this example, four points along the optical fiber cable 30 are defined as measurement points C1, C2, C3, and C4, and measurement signals D1, D2, D3, and D4 are measured at the measurement points respectively. Here, measurement signals are time-series signals having a predetermined time width. For example, they may be acoustic signals such as dog's barks, human voices, and tweet of a bird, and vibration signals such as human footfalls. The signal measurement device 20 transmits measurement signals measured at the respective measurement points to the signal processing device 10 together with information identifying the measurement points. While the number of measurement points and the intervals thereof by the signal measurement device 20 depend on the performance of the DAS device used, measurement signals may be measured at any number of measurement points at any intervals. Moreover, the signal measurement device 20 is not limited to a DAS device, and the measurement signals are not limited to acoustic signals or vibration signals. Any signals may be measured by using any devices.

The signal processing device 10 is configured of one or a plurality of information processing devices each having an arithmetic device and a storage device. As illustrated in FIG. 2, the signal processing device 10 includes an acquisition unit 11, a prediction unit 12, a space information extraction unit 13, a similarity calculation unit 14, and a correction unit 15. The functions of the acquisition unit 11, the prediction unit 12, the space information extraction unit 13, the similarity calculation unit 14, and the correction unit 15 can be implemented through execution, by the arithmetic device, of a program for implementing the respective functions stored in the storage device. The signal processing device 10 further includes a signal storage unit 16 and a model storage unit 17. Each of the signal storage unit 16 and the model storage unit 17 is configured of a storage device. Hereinafter, the respective constituent elements will be described in detail.

The acquisition unit 11 acquires measurement signals at respective measurement points measured by the signal measurement device 20 as described above, and stores them in the signal storage unit 16. For example, the acquisition unit 11 acquires the measurement signals D1, D2, D3, and D4 at four places, namely, the measurement points C1, C2, C3, and C4 along the optical fiber cable 30 as illustrated in FIG. 2, and stores them in association with identification information of the respective measurement points. As an example, a measurement signal x, is defined as Expression 1 provided below.

x_{c}∈ [symbol] : time−sereis signal of series length T observed at channel c [Expression 1]

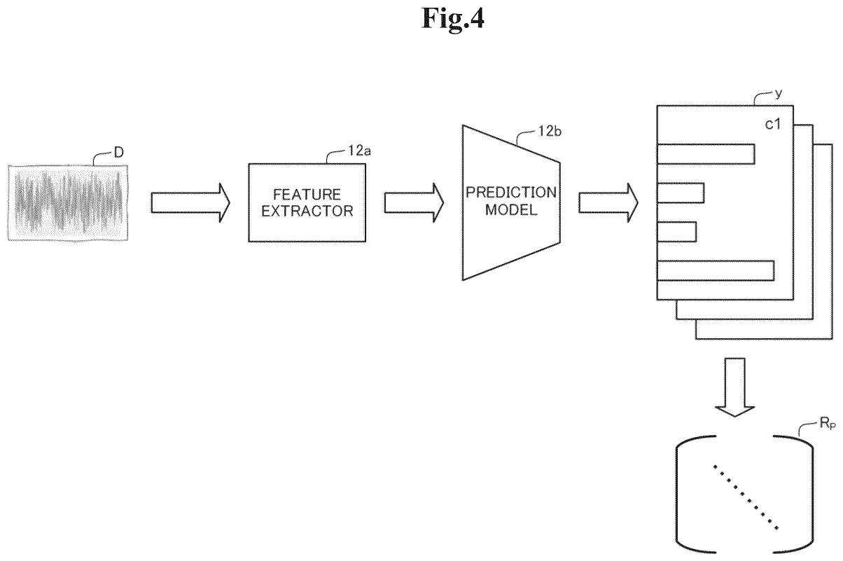

The prediction unit 12 predicts an event (predictive environment) representing the environment of the corresponding measurement point, on the basis of the measurement signal acquired as described above. Specifically, the prediction unit 12 of the present embodiment first extracts a feature value from the measurement signal D at a predetermined measurement point C by using a feature extractor 12a as illustrated in FIG. 4. The feature extractor 12a extracts a frequency feature by applying Fourier transform, wavelet transform, Constant Q transform (CQT), or the like to the time-series signal that is a measurement signal, for example. Note that the feature extractor 12a may extract phase information or amplification of a measurement signal as a feature value, without being limited to a frequency feature.

Then, the prediction unit 12 inputs the feature value extracted from the measurement signal into a predetermined prediction model to predict a predictive event y at the measurement point C. Here, a prediction model 12b is a machine learning model generated by machine-learning the training data in advance. For example, it is generated by performing machine learning to optimize the parameter of the machine learning model by using, as training data, a pair of a feature value extracted from a measurement signal consisting of an acoustic signa or a vibration signal measured from each measurement point in advance, and a teacher signal that is an event occurring at the measurement point, and is stored in the model storage unit 17. As illustrated in FIG. 4, the prediction model 12b of the present embodiment inputs therein the measurement signal D at the channel C that is each measurement point, and outputs a predictive event set y that is a set of predictive values in a plurality of types of events set in advance. That is, the prediction model 12b is defined by Expression 2 provided below, and outputs a predictive value of each predictive event set in advance for each channel C, as expressed by Expression 3 provided below. Here, each predictive value represents a probability that the measurement signal corresponds to each predictive event, and it is assumed that as the numerical value is larger, the probability is higher.

ŷ_{c}∈[0,1]^{K}: event type set predicted at chennel c [Expression 2]

Here, K represents the total number of event types defined in advance, and it is assumed that the number of predictive values to be output is equal to the total number K of events. Therefore, the predictive event set y is represented as a vector as expressed by Expression 3, when the channel c=1 and the total number K of event types=3.

ŷ₁∈(0.0,0.3,0.9) [Expression 3]

Here, as expressed by Expression 3, the predictive value may be represented as a continuous value representing the probability that it may correspond to each predictive event, or may be represented as a binary in which “0” represents nonoccurrence of an event and “1” represents occurrence.

As an example, events in the case where the total number K of types=3 in the above example include “place: city area”, “place: forest”, and “place: park”. In this case, for each of the four measurement points C1, C2, C3, and C4 illustrated in FIG. 2 described above, a predictive event set that is a set of predictive values that may correspond to each event as indicated by Expression 3 is output.

Then, the present embodiment is configured to correct the predictive event set that is a set of predictive events predicted by the prediction unit 12, by the space information extraction unit 13, the similarity calculation unit 14, and the correction unit 15.

The space information extraction unit 13 generates an event space correlation matrix R_{P} (first relationship information) expressed by Expression 4 described below, on the basis of the predictive event set y expressed by Expression 3 calculated as described above.

$${R}_{P} = ( \begin{matrix}1 & {γ}_{12} & … & {γ}_{1 M} \\ {γ}_{21} & 1 & … & {γ}_{2 M} \\ ⋮ & ⋮ & 1 & ⋮ \\ {γ}_{N 1} & {γ}_{N 2} & … & 1\end{matrix} ) \\ {γ}_{nm} = corr ( {\hat{y}}_{n} , {\hat{y}}_{m} ) \qquad [ Expression 4 ]$$

The event space correlation matrix R_{P} is defined by a matrix having a size of channel by channel, as expressed by Expression 4. Here, an element γₙₘ of the event space correlation matrix R_{P} is a value representing the relationship of the predictive event sets y between channels (between measurement points). As an example, the element γₙₘ is obtained by calculating a Pearson's correlation coefficient (corr(•)) of a predictive event set between two channels with respect to every combination. The elements γₙₘ are aligned to form the event space correlation matrix R_{P}. As corr(•) for calculating each element, distance, pseudometric, or a similarity function such as dispersion, Euclidean distance, Kullback-Leibler divergence, cosine similarity, or the like may be used.

Moreover, the space information extraction unit 13 generates a measurement signal space correlation matrix R_{A} (second relationship information) as expressed by Expression 5 provided below, on the basis of the measurement signal.

$${R}_{A} = ( \begin{matrix}1 & {ρ}_{12} & … & {ρ}_{1 M} \\ {ρ}_{21} & 1 & … & {ρ}_{2 M} \\ ⋮ & ⋮ & 1 & ⋮ \\ {ρ}_{N 1} & {ρ}_{N 2} & … & 1\end{matrix} ) \\ {ρ}_{nm} = corr ( {x}_{n} , {x}_{m} ) \qquad [ Expression 5 ]$$

As expressed by Expression 5, the measurement signal space correlation matrix R_{A} is defined by a matrix having a size of channel by channel. Here, the element ρₙₘ of the measurement signal space correlation matrix R_{A} is a value representing the relationship between measurement signals of the channels (measurement points), and is calculated similarly to the element of the event signal space matrix described above. As an example, the element ρₙₘ is obtained by calculating a Pearson's correlation coefficient (corr(•)) of measurement signals between two channels with respect to every combination. The element ρₙₘ are aligned to form the measurement signal space correlation matrix R_{A}. Note that a measurement signal x used in corr(•) calculating each element is an amplitude spectrum obtained by taking an absolute value after the discrete Fourier transform with respect to a measurement signal of a channel. However, the measurement signal x may be power, phase spectrum, or a time region signal.

The similarity calculation unit 14 calculates similarity between the event space correlation matrix R_{P} (first relationship information) and the measurement signal space correlation matrix R_{A} (second relationship information) calculated as described above. Specifically, as expressed by Expression 6, the similarity calculation unit 14 calculates the similarity between corresponding elements (γₙₘ, ρₙₘ) of the event space correlation matrix R_{P} and the measurement signal space correlation matrix R_{A}, that is, similarity aₙₘ between elements corresponding to the same channels, and takes the total sum aₘ in the row direction or column direction of the matrix to thereby calculate a vector “a” of the number of dimensions that is equal to the number of channels.

$${a}_{nm} = exp ( - \vert {ρ}_{nm} - {γ}_{nm} \vert ) \\ {a}_{m} = {\sum }_{n = 1}^{N} {a}_{nm} \\ \begin{matrix}a = [ {a}_{1} , … , {a}_{m} , … , {a}_{M} ] \\ = [ {a}_{1} , … , {a}_{c} , … , {a}_{C} ]\end{matrix} \qquad [ Expression 6 ]$$

Here, it is considered that when prediction of an event at each measurement point by the prediction model 12b is spatially correct, it conforms to spatial information of a measurement signal measured at each measurement point. Therefore, when the prediction by the prediction model 12b is correct, the similarity between the elements of the event space correlation matrix R_{P} and the measurement signal space correlation matrix R_{A} is high, and the similarity between the elements of the vector “a” may be high. As a result, it can be said that the similarity corresponding to each channel that is each element of the vector “a” calculated as described above represents the reliability of the prediction result by the prediction model at each channel.

The correction unit 15 corrects the prediction result by the prediction model by using the vector “a” representing the reliability of each channel calculated as described above. For example, as expressed by Expression 7 provided below, with respect to a predictive event set yc of each channel by the prediction model, a predictive value included in the predictive event set is corrected by giving a weight to the reliability of each channel by the vector “a”.

$${y}_{c}^{′} = {a}_{m} {\hat{y}}_{c} \qquad [ Expression 7 ]$$

For the correction of a predictive event as described above, correction can be made by giving a weight using a softmax function or by using only some channels having higher reliability, rather than simple multiplication. For example, it is possible to make a correction in which an importance is not placed on a prediction result of a channel having lower reliability, as compared with other channels.

### [Operation]

Next, operation of the signal processing device 10 will be described.

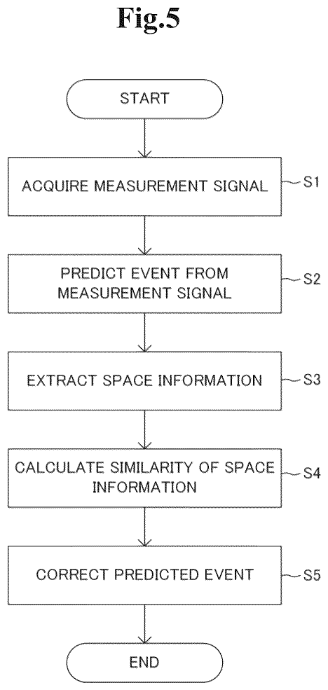

First, the signal processing device 10 acquires measurement signals at respective measurement points along the optical fiber cable 30 measured by the signal measurement device 20 (step S1 in FIG. 5). For example, the signal processing device 10 acquires measurement signals D1, D2, D3, and D4 at four places, namely, the measurement points C1, C2, C3, and C4 along the optical fiber cable 30 as illustrated in FIG. 2.

Then, the signal processing device 10 predicts an event representing the environment of the corresponding measurement point, on the basis of the acquired measurement signal (step S2 in FIG. 5). Specifically, the signal processing device 10 first extracts a feature value from the measurement signal D at the predetermined measurement point C by using the feature extractor 12a, as illustrated in FIG. 4. Then, the signal processing device 10 inputs the feature value into the predetermined prediction model 12b and outputs the predictive event y at the measurement point C to make a prediction. At that time, the signal processing device 10 outputs the predictive event set yc that is a set of predictive values of a plurality of types of events at the channel C that is each measurement point, as expressed by Expression 2 and Expression 3.

Then, on the basis of the calculated predictive event set y, the signal processing device 10 generates the event space correlation matrix R_{P} expressed as Expression 4 (step S3 in FIG. 5). The event space correlation matrix R_{P} is defined by a matrix having a size of channel by channel, and has an element representing the relationship of the predictive event sets y between respective channels (between respective measurement points). Further, on the basis of the measurement signal, the signal processing device 10 generates the measurement signal space correlation matrix R_{A} expressed as Expression 5 (step S3 in FIG. 5). The measurement signal space correlation matrix R_{A} is defined by a matrix having a size of channel by channel, and has an element representing the relationship of the measurement signals between respective channels (between respective measurement points).

Then, the signal processing device 10 calculates the similarity between the calculated event space correlation matrix R_{P} and the measurement signal space correlation matrix R_{A} (step S4 in FIG. 5). Specifically, the similarity calculation unit 14 calculates the similarity between the corresponding elements (γₙₘ, ρₙₘ) of the event space correlation matrix R_{P} and the measurement signal space correlation matrix R_{A}, that is, the similarity aₙₘ between the elements corresponding to the same channels, as expressed by Expression 6, and takes the total sum aₘ in the row direction or the column direction of the matrix to thereby calculate a vector “a” having the number of dimensions that is equal to the number of channels. Here, it can be said that the vector “a” represents the reliability of the measurement result at each channel by the prediction model.

Then, the signal processing device 10 corrects the predictive event set by the prediction model, by using the vector “a” representing the calculated reliability of the prediction result of each channel. For example, as expressed by Expression 7 provided above, the signal processing device 10 corrects the prediction result by giving a weight to the reliability of each channel by the vector “a” with respect to the predictive event set yc of each channel by the prediction model.

As described above, the signal processing device 10 of the present embodiment first calculates an event space correlation matrix representing the spatial relationship of prediction results by the prediction model and a measurement signal space correlation matrix representing the spatial relationship of measurement signals. Then, the signal processing device 10 calculates the similarity by comparing respective spatial correlation matrixes, whereby calculates the reliability of the prediction result by the prediction model, and corrects the prediction result by the prediction model by using the reliability. Therefore, even in the case of a measurement signal that largely deviates from the training data used at the time of generating the prediction model, it is possible to correct the prediction in consideration of spatial relationship of the measurement signal, and to improve the prediction accuracy of the event.

For example, in the measurement data D2 and D4 measured at the measurement points C2 and C4 along the optical fiber cable 30 as illustrated in FIG. 2, noise components are larger as compared with those of other measurement points. In that case, signals due to events occurring at the measurement points C2 and C4 are less likely to be recognized. This is because various types of noises are estimated due to disturbance caused by optical factors of the optical fiber cable 30 or laid environment, so it may be difficult to grasp all of them in advance. As a result, the prediction accuracy by the prediction model is considered to be lowered. Even in such a situation, in the present embodiment, it is possible to correct the prediction result by the prediction model by using the similarity between the spatial relationship of the prediction results by the prediction model and the spatial relationship of the measurement signals, and to improve the prediction accuracy.

### Second Example Embodiment

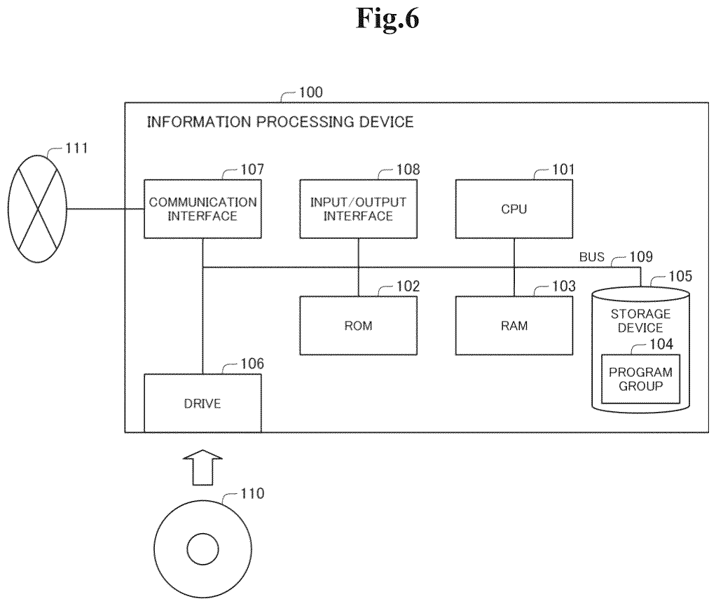

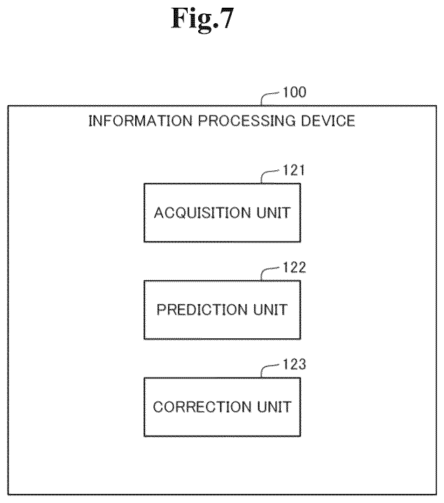

Next, a second example embodiment of the present disclosure will be described with reference to the drawings. The present embodiment shows the outlines of the configuration of the signal processing device explained in the above-described embodiment. Note that FIGS. 6 and 7 are drawings for explaining the configuration, and may relate to any embodiments.

First, a hardware configuration of an information processing device 100 will be described with reference to FIG. 6. The information processing device 100 is configured of a typical information processing device, having a hardware configuration as described below as an example.
Central Processing Unit (CPU) 101 (arithmetic device)
Read Only Memory (ROM) 102 (storage device)
Random Access Memory (RAM) 103 (storage device)
Program group 104 to be loaded to the RAM 103
Storage device 105 storing therein the program group 104
Drive 106 that performs reading and writing on a storage medium 110 outside the
information processing device
Communication interface 107 connecting to a communication network 111 outside the information processing device
Input/output interface 108 for performing input/output of data
Bus 109 connecting the respective constituent elements

Note that FIG. 6 illustrates an example of a hardware configuration of an information processing device that is the information processing device 100. The hardware configuration of the information processing device is not limited to that described above. For example, the information processing device may be configured of part of the configuration described above, such as without the drive 106. Moreover, instead of the CPU, the information processing device may use a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof.

The information processing device 100 can construct, and can be equipped with, an acquisition unit 121, a prediction unit 122, and a correction unit 123 illustrated in FIG. 7 through acquisition and execution of the program group 104 by the CPU 101. Note that the program group 104 is stored in the storage device 105 or the ROM 102 in advance, and is loaded to the RAM 103 and executed by the CPU 101 as needed. Further, the program group 104 may be supplied to the CPU 101 via the communication network 111, or may be stored on the storage medium 110 in advance and read out by the drive 106 and supplied to the CPU 101. However, the acquisition unit 121, the prediction unit 122, and the correction unit 123 may be constructed by dedicated electronic circuits for implementing such means.

The acquisition unit 121 acquires measurement signals measured at a plurality of measurement points on a laid optical fiber cable.

The prediction unit 122 predicts a predictive environment representing the environment of each measurement point from each measurement signal by using a predetermined prediction model.

The correction unit 123 corrects the predictive environment on the basis of a comparison between the predictive environment of each measurement point and the measurement signal measured as the measurement point. For example, the correction unit generates first relationship information representing the relationship of the predictive environments between the measurement points and second relationship information representing the relationship of the measurement signals between the measurement points, and corrects the predictive environment on the basis of the comparison between the first relationship information and the second relationship information.

Since the present disclosure is configured as described above, a prediction result by the prediction model is corrected on the basis of the comparison between the prediction result by the prediction model and the measurement signal. Therefore, even in the case of a measurement signal that largely deviates from the training data used at the time of generating the prediction model, it is possible to correct the prediction from the comparison result, and to improve the prediction accuracy.

Further, at least one of the functions of the acquisition unit 121, the prediction unit 122, and the correction unit 123 described above may be carried out by an information processing device provided and connected to any location on the network, that is, may be carried out by so-called cloud computing.

The program described above can be supplied to a computer by being stored on a non-transitory computer-readable medium of any type. Non-transitory computer-readable media include tangible storage media of various types. Examples of non-transitory computer-readable media include magnetic storage media (for example, flexible disk, magnetic tape, and hard disk drive), magneto-optical storage media (for example, magneto-optical disk), a CD-ROM (Read Only Memory), a CD-R, a CD-R/W, and semiconductor memories (for example, mask ROM, PROM (Programmable ROM), EPROM (Erasable PROM), flash ROM, and RAM (Random Access Memory)). The program may be supplied to a computer by a transitory computer-readable medium of any type. Examples of transitory computer-readable media include electric signals, optical signals, and electromagnetic waves. A transitory computer-readable medium can supply a program to a computer via a wired communication channel such as a wire and an optical fiber, or a wireless communication channel.

While the present disclosure has been described with reference to the example embodiments described above, the present disclosure is not limited to the above-described embodiments. The form and details of the present disclosure can be changed within the scope of the present disclosure in various manners that can be understood by those skilled in the art. Moreover, the example embodiments may be combined with other example embodiments as appropriate.

### Supplementary Notes

The whole or part of the example embodiments disclosed above can be described as the following supplementary notes. Hereinafter, outlines of the configurations of an information processing device, an information processing method, and a program, according to the present disclosure, will be described. However, the present disclosure is not limited to the configurations described below.

### (Supplementary Note 1)

An information processing device comprising:
an acquisition unit that acquires measurement signals measured at a plurality of measurement points on a laid optical fiber cable;
a prediction unit that predicts a predictive environment representing an environment of each of the measurement points from each of the measurement signals by using a prediction model set in advance; and
a correction unit that corrects the predictive environment on a basis of a comparison between the predictive environment of each of the measurement points and the measurement signal measured at each of the measurement points.

### (Supplementary Note 2)

The information processing device according to supplementary note 1, wherein
the correction unit generates first relationship information representing a relationship of the predictive environments between the measurement points, and second relationship information representing a relationship of the measurement signals between the measurement points, and corrects the predictive environment on a basis of a comparison between the first relationship information and the second relationship information.

### (Supplementary Note 3)

The information processing device according to supplementary note 2, wherein
the correction unit corrects the predictive environment on a basis of a similarity between the first relationship information and the second relationship information.

### (Supplementary Note 4)

The information processing device according to supplementary note 2 or 3, wherein
for each of the measurement points, the prediction unit predicts a predictive value with respect to each of a plurality of types of environment set in advance as the predictive environment, by using the prediction model, and
the correction unit generates a relationship of the predictive values that are predictive environments between the measurement points as the first relationship information.

### (Supplementary Note 5)

The information processing device according to supplementary note 4, wherein
the correction unit generates the first relationship information in which a relationship of the predictive values between two of the measurement points serves as each element, and generates the second relationship information in which a relationship of the measurement signals between two of the measurement points serves as each element.

### (Supplementary Note 6)

The information processing device according to supplementary note 5, wherein
the correction unit corrects the predictive environment on a basis of a similarity between the elements corresponding to same two measurement points in the first relationship information and the second relationship information.

### (Supplementary Note 7)

The information processing device according to supplementary note 6, wherein
the correction unit calculates a reliability of the predictive environment at each of the measurement points on a basis of the similarity between the elements, and corrects the predictive environment on a basis of the reliability of each of the measurement points.

### (Supplementary Note 8)

An information processing method comprising:
acquiring measurement signals measured at a plurality of measurement points on a laid optical fiber cable;
predicting a predictive environment representing an environment of each of the measurement points from each of the measurement signals by using a prediction model set in advance; and
correcting the predictive environment on a basis of a comparison between the predictive environment of each of the measurement points and the measurement signal measured at each of the measurement points.

### (Supplementary Note 9)

The information processing method according to supplementary note 8, further comprising
generating first relationship information representing a relationship of the predictive environments between the measurement points, and second relationship information representing a relationship of the measurement signals between the measurement points, and correcting the predictive environment on a basis of a comparison between the first relationship information and the second relationship information.

### (Supplementary Note 10)

A program for causing cause a computer to execute processing to:
acquire measurement signals measured at a plurality of measurement points on a laid optical fiber cable;
predict a predictive environment representing an environment of each of the measurement points from each of the measurement signals by using a prediction model set in advance; and
correct the predictive environment on a basis of a comparison between the predictive environment of each of the measurement points and the measurement signal measured at each of the measurement points.

### REFERENCE SIGNS LIST

10 signal processing device
11 acquisition unit
12 prediction unit
13 space information extraction unit
14 similarity calculation unit
15 correction unit
16 signal storage unit
17 model storage unit
20 signal measurement device
30 optical fiber cable
100 information processing device
101 CPU
102 ROM
103 RAM
104 program group
105 storage device
106 drive
107 communication interface
108 input/output interface
109 bus
110 storage medium
111 communication network
121 acquisition unit
122 prediction unit
123 correction unit

1. An information processing device comprising:
at least one memory configured to store instructions; and
at least one processor configured to execute instructions to:
acquire measurement signals measured at a plurality of measurement points on a laid optical fiber cable;
predict a predictive environment representing an environment of each of the measurement points from each of the measurement signals by using a prediction model set in advance; and
correct the predictive environment on a basis of a comparison between the predictive environment of each of the measurement points and the measurement signal measured at each of the measurement points.

2. The information processing device according to claim 1, wherein the at least one processor is configured to execute the instructions to:
generate first relationship information representing a relationship of the predictive environments between the measurement points, and second relationship information representing a relationship of the measurement signals between the measurement points, and correct the predictive environment on a basis of a comparison between the first relationship information and the second relationship information.

3. The information processing device according to claim 2, wherein the at least one processor is configured to execute the instructions to
correct the predictive environment on a basis of a similarity between the first relationship information and the second relationship information.

4. The information processing device according to claim 2, wherein the at least one processor is configured to execute the instructions to:
for each of the measurement points, predict a predictive value with respect to each of a plurality of types of environment set in advance as the predictive environment, by using the prediction model; and
generate a relationship of the predictive values that are predictive environments between the measurement points as the first relationship information.

5. The information processing device according to claim 4, wherein the at least one processor is configured to execute the instructions to
generate the first relationship information in which a relationship of the predictive values between two of the measurement points serves as each element, and generate the second relationship information in which a relationship of the measurement signals between two of the measurement points serves as each element.

6. The information processing device according to claim 5, wherein the at least one processor is configured to execute the instructions to
correct the predictive environment on a basis of a similarity between the elements corresponding to same two measurement points in the first relationship information and the second relationship information.

7. The information processing device according to claim 6, wherein the at least one processor is configured to execute the instructions to
calculate a reliability of the predictive environment at each of the measurement points on a basis of the similarity between the elements, and correct the predictive environment on a basis of the reliability of each of the measurement points.

8. An information processing method comprising:
acquiring measurement signals measured at a plurality of measurement points on a laid optical fiber cable;
predicting a predictive environment representing an environment of each of the measurement points from each of the measurement signals by using a prediction model set in advance; and
correcting the predictive environment on a basis of a comparison between the predictive environment of each of the measurement points and the measurement signal measured at each of the measurement points.

9. The information processing method according to claim 8, further comprising
generating first relationship information representing a relationship of the predictive environments between the measurement points, and second relationship information representing a relationship of the measurement signals between the measurement points, and correcting the predictive environment on a basis of a comparison between the first relationship information and the second relationship information.

10. The information processing method according to claim 9, further comprising
correcting the predictive environment on a basis of a similarity between the first relationship information and the second relationship information.

11. The information processing method according to claim 9, further comprising:
for each of the measurement points, predicting a predictive value with respect to each of a plurality of types of environment set in advance as the predictive environment, by using the prediction model; and
generating a relationship of the predictive values that are predictive environments between the measurement points as the first relationship information.

12. The information processing method according to claim 11, further comprising
generating the first relationship information in which a relationship of the predictive values between two of the measurement points serves as each element, and generating the second relationship information in which a relationship of the measurement signals between two of the measurement points serves as each element.

13. The information processing method according to claim 12, further comprising
correcting the predictive environment on a basis of a similarity between the elements corresponding to same two measurement points in the first relationship information and the second relationship information.

14. The information processing method according to claim 13, further comprising
calculating a reliability of the predictive environment at each of the measurement points on a basis of the similarity between the elements, and correcting the predictive environment on a basis of the reliability of each of the measurement points.

15. A non-transitory computer-readable medium storing thereon a program comprising instructions for causing a computer to execute processing to:
acquire measurement signals measured at a plurality of measurement points on a laid optical fiber cable;
predict a predictive environment representing an environment of each of the measurement points from each of the measurement signals by using a prediction model set in advance; and
correct the predictive environment on a basis of a comparison between the predictive environment of each of the measurement points and the measurement signal measured at each of the measurement points.
